(19) United States
(12) Patent Application Publication
(10) Pub. No.: US 2005/0039198 A1
(43) Pub. Date: Feb. 17, 2005

(54) Optical disc drive with ventilation structure

(75) Inventor: Xian-Qing You, ShenZhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/930,209

(22) Filed: Aug. 31, 2004

(30) Foreign Application Priority Data
Aug. 11, 2003 (CN) 200320117985.3

(51) Int. Cl. G11B 17/03

(52) U.S. Cl. 720/603

(57) ABSTRACT

An optical disc drive includes a tray, a frame, and a traverse module. The tray includes a circular disc loader adapted to support an optical disc therein, a feeding slot, and two gaps at opposite sides of the tray. The frame includes two side walls with a plurality of stoppers provided thereon, a tray loader, two protrusions provided on inner surfaces of the side walls, and two ventilation grooves between the protrusions and the side walls. When the optical disc drive is used as a vertical tray loading disc drive, an optical disc is loaded in the disc loader of the tray. The protrusions are located at the gaps of the tray, and prevent the disc from falling out of the disc loader. Airflow around the rotating disc is smoothly expelled out of the tray via the gaps and the ventilation grooves. Noise produced by the airflow is reduced accordingly.

### BACKGROUND OF THE INVENTION

1. Field of the Invention

The present invention generally relates to an optical disc drive with a ventilation structure, and more particularly a ventilation structure that can reduce noise generated by an optical disc rotating at high speed.

2. Description of the Related Art

Optical discs have become increasingly popular for use as storage devices for computers and other digital devices in recent years. Users' basic requirements for optical discs have become more and more rigorous over time. Optical disc drives are the devices used to record/reproduce information to/from optical discs, and the basic requirements for optical disc drives have become more and more rigorous too. The desired features include fast reading/writing speed, short access time, anti-vibration, anti-noise, and horizontal and vertical tray loading capability.

Generally, an optical disc drive is used in a horizontal orientation. During horizontal tray loading and unloading, a disc is loaded into a circular recess of the tray, and the tray slides into and out from the optical disc drive in a horizontal plane. During vertical tray loading, the tray slides into and out from the optical disc drive in a vertical plane. In order to support both horizontal and vertical tray loading, most optical disc drives have specific stabilizing structures for the disc. For example, claw-shaped portions are provided around a periphery of the circular recess of the tray, in order to prevent the disc from falling out from the circular recess.

However, the claw-shaped portions form uneven surfaces around the periphery of the circular recess. Airflow around the high-speed rotating disc produces a lot of noise at the uneven surfaces, which is an annoyance for users. Therefore, a means for ventilating the airflow and dampening the noise is desired.

### SUMMARY OF THE INVENTION

Accordingly, an object of the present invention is to provide an optical disc drive which supports both horizontal and vertical tray loading and which has a ventilation structure for dampening airflow noise.

In order to achieve the object set out above, an optical disc drive of the present invention comprises a tray, a frame, and a traverse module fixed in the frame. The tray comprises a substantially circular disc loader adapted to support an optical disc therein, a feeding slot, and two gaps at opposite sides of the tray. The frame comprises two side walls with a plurality of stoppers provided thereon, a tray loader between the side walls, two protrusions provided on inner surfaces of the side walls, and two ventilation grooves each defined between one of the protrusions and a corresponding one of the side walls. The traverse module housed in the frame comprises a turntable, an optical pickup unit, and a base supporting the turntable and the optical pickup unit thereon. When the optical disc drive is used as a vertical tray loading disc drive, an optical disc is loaded in the disc loader of the tray. Claw portions of the tray hold the optical disc inside the disc loader, and prevent the optical disc from falling out of the disc loader under its own weight. The protrusions of the side walls are located at the gaps of the tray, and prevent the optical disc from falling out of the disc loader under its own weight. The optical disc is rotated at high speed by the turntable. Airflow around the rotating optical disc is smoothly expelled out of the tray via the gaps and the ventilation grooves. Noise produced by the airflow is reduced accordingly.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an optical disc drive in accordance with the present invention;

FIG. 2 is an enlarged view of a circled portion II of FIG. 1;

FIG. 3 is an assembled view of the optical disc drive of FIG. 1, showing the optical disc drive providing horizontal tray loading; and

FIG. 4 is an assembled, side elevation of the optical disc drive of FIG. 1, showing the optical disc drive providing vertical tray loading.

### DETAILED DESCRIPTION OF THE INVENTION

Reference will now be made to the drawing figures to describe the preferred embodiment of the present invention in detail.

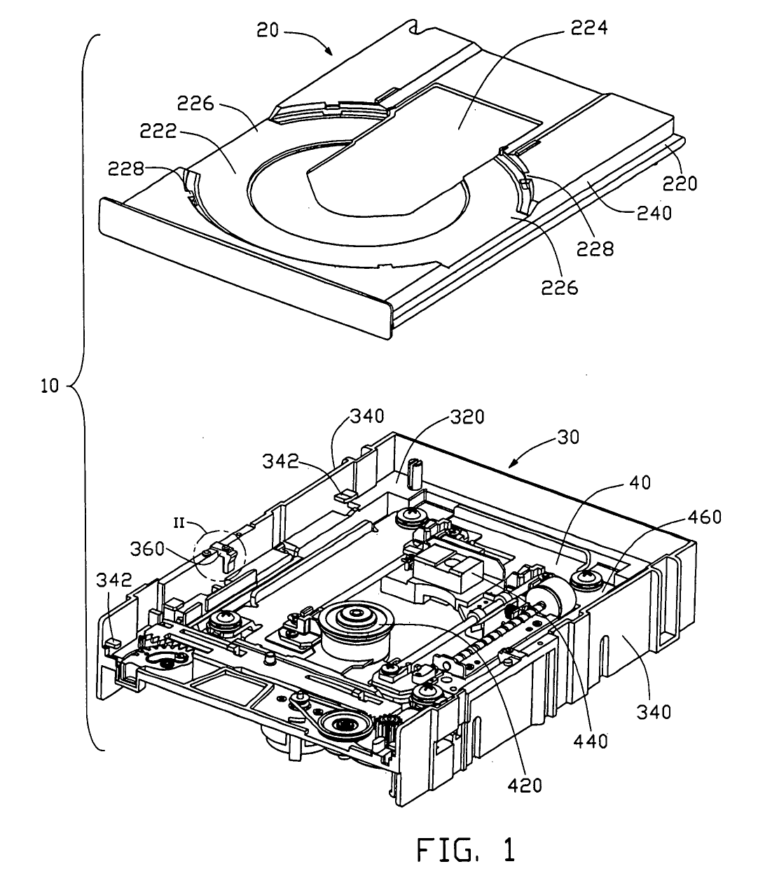

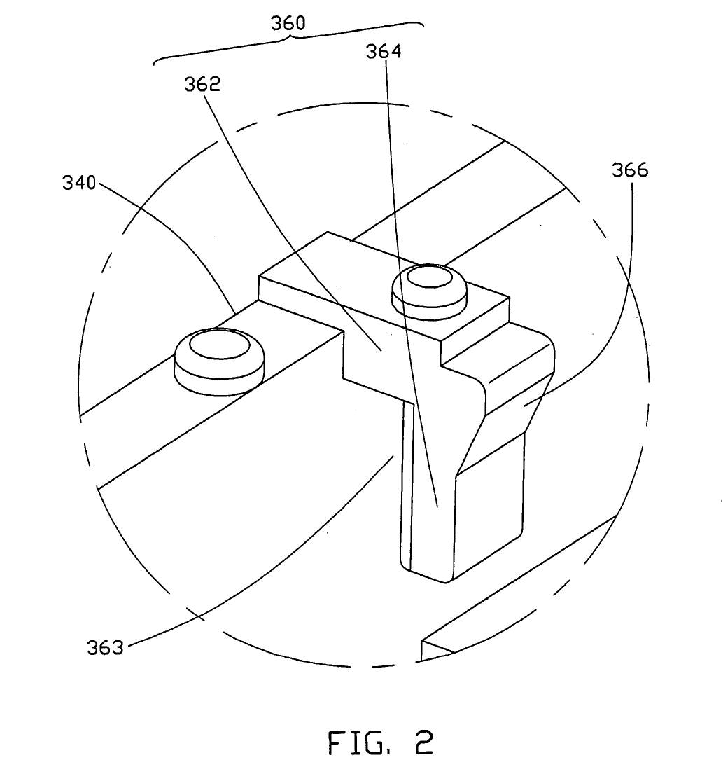

Referring to FIGS. 1 and 2, an optical disc drive 10 in accordance with the preferred embodiment of the invention is shown. The optical disc drive 10 comprises a tray 20, a frame 30, and a traverse module 40. The traverse module 40 is mounted in the frame 30, and the tray 20 can slide into and out from the frame 30.

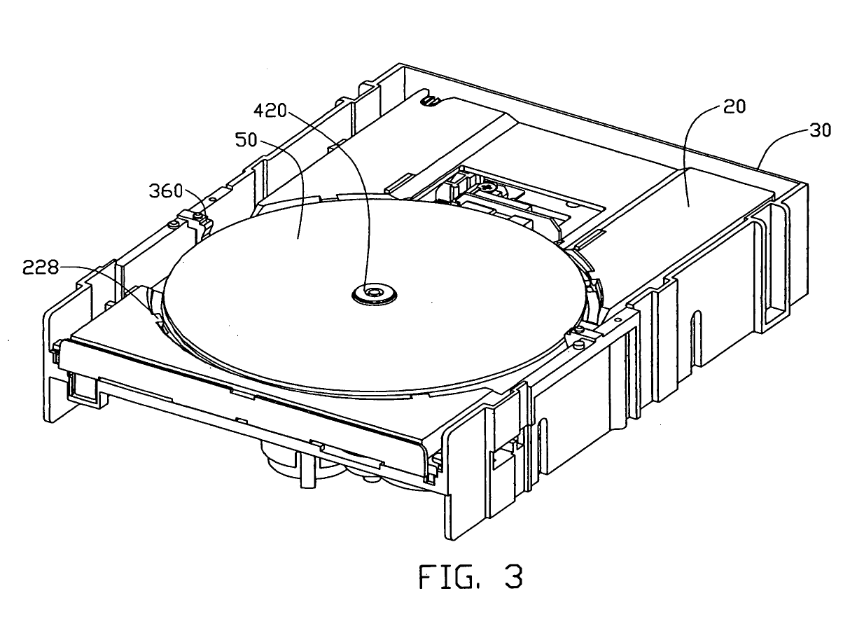

The tray 20 is substantially rectangular. The tray 20 comprises a pair of sliding strips 220 horizontally formed on opposite sides thereof respectively, a disc loader 222 defining a substantially circular indentation at a top surface of the tray 20 for receiving a correspondingly sized optical disc 50 (see FIG. 3), an arch-shaped feeding slot 224, two gaps 226 respectively defined in opposite side surfaces 240 of the tray 20 at the indentation, and four claw portions 228, used as a restriction mechanism, symmetrically formed above a peripheral portion of the disc loader 222 to restrict any movement of the loaded disc away from the tray.

The frame 30 comprises two side walls 340, and a tray loader 320 provided between the side walls 340. A plurality of aligned stoppers 342 extends inwardly from each of the side walls 340. Each line of stoppers 342 is parallel to the tray loader 320. The sliding strips 220 of the tray 20 are inserted in spaces defined between the tray loader 320 and the stoppers 342. Two L-shaped protrusions 360 are provided on inner surfaces of the side walls 340 respectively. Each L-shaped protrusion 360 used as another restriction mechanism comprises a horizontal portion 362, a vertical portion 364, and a wedge portion 366. The horizontal portion 362 extends inwardly from a top of the side wall 340. The vertical portion 364 extends downwardly from a distal end of the horizontal portion 364. The wedge portion 366 is formed at an inmost face of the vertical portion 364, near the junction of the horizontal portion 362 and the vertical portion 364. A bevel of the wedge portion 366 faces an inside of the frame 30. A ventilation groove 363 is defined as a passageway between the vertical portion 366 and the side wall 340.

The traverse module 40 comprises a turntable 420, an optical pickup unit 440, and a base 460. When the tray 20 loaded with an optical disc 50 moves into the frame 30, the traverse module 40 is raised automatically so that it contacts the optical disc 50. In particular, the turntable 420 and the optical pickup unit 440 are raised up through the feeding slot 224. The turntable 420 rotates the optical disc 50, and the optical pickup unit 440 moves along the feeding slot 224 for reading/recording information from/to the optical disc 50.

Referring to FIG. 3, when the optical disc drive 10 is used as a horizontal tray loading disc drive, the tray 20 slides into and out from the frame 30 in a horizontal orientation. An optical disc 50 is loaded in the disc loader 222 of the tray 20 and is rotated at high speed by the turntable 420. Airflow around the rotating disc 50 is smoothly expelled out of the tray 20 via the gaps 226 of the tray 20 and the ventilation grooves 363 of the protrusions 360. Noise produced by the airflow is reduced accordingly.

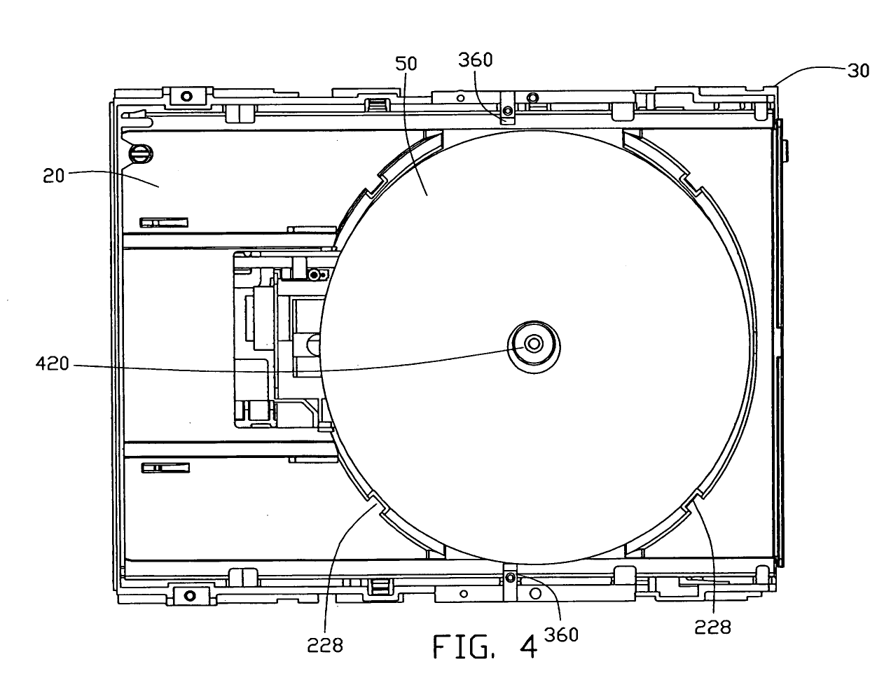

Referring also to FIG. 4, when the optical disc drive 10 is used as a vertical tray loading disc drive, the tray 20 slides into and out from the frame 30 in a vertical orientation. An optical disc 50 is loaded in the disc loader 222 of the tray 20. The claw portions 228 of the tray 20 hold the optical disc 50 inside the disc loader 222, and prevent the optical disc 50 from falling out of the disc loader 222 under its own weight. The protrusions 360 of the side walls 340 are located at the gaps 226 of the tray 20. The bevels of the wedge portions 366 thus also prevent the optical disc 50 from falling out of the disc loader 222 under its own weight. The optical disc 50 is rotated at high speed by the turntable 420. Airflow around the rotating optical disc 50 is smoothly expelled out of the tray 20 via the gaps 226 of the tray 20 and the ventilation grooves 363 of the protrusions 360. Noise produced by the airflow is reduced accordingly.

Although the present invention has been described with reference to specific embodiments, it should be noted that the described embodiments are not necessarily exclusive, and that various changes and modifications may be made to the described embodiments without departing from the scope of the invention as defined by the appended claims.

1. An optical disc drive, comprising:
a tray comprising a substantially circular disc loader adapted to support an optical disc therein, a feeding slot, and two gaps at opposite sides of the tray;
a frame comprising two side walls with a plurality of stoppers provided thereon, a tray loader between the side walls, two protrusions provided on inner surfaces of the side walls, and two ventilation grooves each defined between one of the protrusions and a corresponding one of the side walls; and
a traverse module housed in the frame and including a turntable, an optical pickup unit, and a base supporting the turntable and the optical pickup unit thereon.

2. The optical disc drive as recited in claim 1, wherein the stoppers on each of the side walls are aligned with each other, for guiding the tray into and out from the frame.

3. The optical disc drive as recited in claim 1, wherein the tray further comprises two horizontal sliding strips on opposite sides thereof, for sliding along the stoppers of the side walls.

4. The optical disc drive as recited in claim 1, wherein each of the protrusions comprises a horizontal portion and a vertical portion.

5. The optical disc drive as recited in claim 4, wherein the horizontal portion extends inwardly from a top of the corresponding side wall, and the vertical portion extends downwardly from an end of the horizontal portion.

6. The optical disc drive as recited in claim 4, wherein each of the protrusions further comprises a wedge portion.

7. The optical disc drive as recited in claim 6, wherein the wedge portion is provided at a junction of the horizontal portion and the vertical portion.

8. The optical disc drive as recited in claim 7, wherein the protrusions are located at the gaps of the tray when the tray is located fully inside the frame, for preventing an optical disc loaded on the tray from being displaced.

9. An optical disc drive comprising:
a tray including two sliding strips, a substantially circular disc loader adapted to support an optical disc therein, a feeding slot, and two gaps defined in sides of the tray;
a frame including two side walls with a plurality of stoppers provided thereon, a tray loader between the side walls, and two protrusions arranged at inner faces of the side walls; and
a traverse module fixed in the frame, the traverse module including a turntable, an optical pickup unit, and a base having the turntable and the optical pickup unit mounted thereon.

10. The optical disc drive as recited in claim 9, wherein each of the protrusions comprises a horizontal portion, a vertical portion, and a wedge portion.

11. The optical disc drive as recited in claim 10, wherein the side walls and the protrusions cooperatively define two grooves thereat, for allowing ventilating airflow.

12. The optical disc drive as recited in claim 10, wherein the horizontal portion extends inwardly from a top of the corresponding side wall, the vertical portion extends downwardly from an end of the horizontal portion, and the wedge portion is provided at a junction of the horizontal portion and the vertical portion.

13. The optical disc drive as recited in claim 12, wherein the protrusions are located at the gaps of the tray when the tray is located fully inside the frame, for preventing an optical disc loaded on the tray from being displaced.

14. The optical disc drive as recited in claim 9, wherein the stoppers on each of the side walls are aligned with each other, and are parallel to the tray loader.

15. The optical disc drive as recited in claim 14, wherein the sliding strips are horizontal, and are provided on opposite sides of the tray, for sliding along the stoppers of the side walls.

16. An optical disc drive, comprising:
a drive frame used to substantially form said optical disc drive, said frame defining an inner space therein;
a tray slidably moving between a first position located in said inner space of said drive frame and a second position located partially outside said frame so as to expose a disc loader of said tray to the ambient environment of said disc drive, said disc loader being adapted to support an optical disc therein;
a traverse module housed in said space of said frame to provide interaction with said optical disc in said tray located in said second position so as to retrieve/record information from/onto said optical, said interaction between said optical disc and traverse module inducing airflow in said space of said drive frame; and
at least one restriction mechanism formed on at least one of said tray and said frame beside the periphery of said disc, a ventilation passageway being defined neighboring said at least one restriction mechanism to provide a bypass for said airflow across said at least one restriction mechanism.
